(19) United States
(12) Patent Application Publication
(10) Pub. No.: US 2021/0076721 A1
(43) Pub. Date: Mar. 18, 2021

(54) BINDER COMPOSITION FOR BAR-SHAPED SOLID FOOD AND BAR-SHAPED SOLID FOOD MANUFACTURED THEREFROM

(71) Applicant: LOTTE FINE CHEMICAL CO., LTD., Ulsan (KR)

(72) Inventors: Eun Ji Lim, Daegu (KR); Sang Youb Lee, Incheon (KR)

(73) Assignee: LOTTE FINE CHEMICAL CO., LTD., Ulsan (KR)

(21) Appl. No.: 16/956,245

(22) PCT Filed: Mar. 23, 2018
(86) PCT No.: PCT/KR2018/003412

§ 371 Date: Jun. 19, 2020

(30) Foreign Application Priority Data
Dec. 22, 2017 (KR) 10-2017-0178746

(51) Int. Cl. A23L 29/262; A23P 10/28; A23L 29/212; A23L 29/30

(52) U.S. Cl. CPC A23L 29/262; A23L 29/30; A23L 29/212; A23P 10/28

(57) ABSTRACT

Disclosed are a binder composition for bar-shaped solid foods, and a bar-shaped solid food including the binder composition for bar-shaped solid foods. The disclosed binder composition for bar-shaped solid foods includes cellulose ether and saccharides.

### TECHNICAL FIELD

A binder composition for bar-shaped solid foods, and a bar-shaped solid food manufactured therefrom are disclosed. More particularly, a binder composition for bar-shaped solid foods, the composition including cellulose ether and saccharides, and a bar-shaped solid food manufactured therefrom are disclosed.

### BACKGROUND ART

In the field of bar-shaped solid foods such as cereal bars, which are widely used as meal substitutes or snacks, food binders are used for formation.

A conventional food binder is based on saccharides such as sugar and starch syrup, and includes high-content of saccharides to impart a binding force. However, in this case, diseases such as obesity due to hyperingestion of saccharides may be caused along with a decrease in mouthfeel due to excessive sugar content. Further, fats such as oil, margarine, and butter, which are used to improve the workability of a food binder, may cause a deterioration of functional quality due to fat rancidity during long-term storage.

As a conventional technology for the food binder, Patent Literature 1 (Korean Patent Registration No. 1303529) discloses a binder composition for bar-shaped foods, including 10 wt % to 90 wt % of sugar and 90 wt % to 10 wt % of polyglycitol. However, this binder composition is problematic in that polyglycitol has lower calories than sugar, but does not digest well in case of hyperingestion, thereby causing intestinal unstability or diarrhea.

### DESCRIPTION OF EMBODIMENTS

### Technical Problem

An embodiment of the present disclosure provides a binder composition for bar-shape solid foods, the composition including cellulose ether and saccharides.

Another embodiment of the present disclosure provides a bar-shaped solid food including the binder composition for bar-shape solid foods.

### Solution to Problem

An aspect of the present disclosure provides

a binder composition for bar-shaped solid foods, the composition including: cellulose ether; and saccharides.

The content of the cellulose ether may be 2 parts by weight to 20 parts by weight with respect to 100 parts by weight of the total content of the saccharides.

The cellulose ether may include alkyl cellulose, hydroxyalkyl cellulose, hydroxyalkyl alkyl cellulose, or any combination thereof.

The cellulose ether may include methyl cellulose, hydroxypropyl methyl cellulose, hydroxyethyl methyl cellulose, hydroxyethyl ethyl cellulose, hydroxyethyl cellulose, or any combination thereof.

An aqueous solution of the cellulose ether having a concentration of 2 wt % may have a viscosity of 3 mPa·s to 600 mPa·s, as measured by an Ubbelohde viscometer, under a condition of 20 ° C.

The saccharides may include sugar, starch syrup, or any combination thereof.

The binder composition for bar-shaped solid foods may further include water, but may not include at least one of fat and gelatin.

An aspect of the present disclosure provides

A bar-shaped solid food manufactured from the binder composition, wherein the bar-shaped solid food includes 100 parts by weight of saccharides and 2 parts by weight to 20 parts by weight of cellulose ether, but does not include at least one of fat and gelatin.

The bar-shaped solid food may be a cereal bar.

### Advantageous Effects Of Disclosure

The binder composition for bar-shaped solid foods according to an embodiment of the present disclosure is excellent in binding force and workability such as releasability.

Further, the bar-shaped solid food manufactured using the binder composition has low calories and excellent binding force and functional quality.

### Mode of Disclosure

Hereinafter, a binder composition for bar-shaped solid foods according to an embodiment of the present invention will be described in detail.

In the present specification, the term “binder composition for bar-shaped solid foods” refers to a composition for binding other components other than the binder composition among components of the bar-shaped solid food.

Further, in the present specification, the term “saccharides” refer to sugar, starch syrup, or a mixture thereof, and excludes cellulose and cellulose ether.

Further, in the present specification, the term “bar-shaped solid food” refers to a non-fluidic food having a constant shape and volume in a state in which no external force is applied.

Further, in the present specification, the term “cereal bar” refers to a snack including cereals for breakfast or snack, the cereals compressed into a bar shape and combined with an edible binder.

Further, in the present specification, the term “total content of saccharides” refers to the sum of solid contents of all saccharide components.

The binder composition for bar-shaped solid foods according to an embodiment of the present disclosure may include cellulose ether and saccharides.

The content of the cellulose ether may be 2 parts by weight to 20 parts by weight with respect to 100 parts by weight of the total content of the saccharides.

When the content of the cellulose ether is less than 2 parts by weight with respect to 100 parts by weight of the total content of the saccharides, there is a problem that workability (for example, releasability) decreases and calories of the final product increase. When the content of the cellulose ether is more than 20 parts by with respect to 100 parts by weight of the total content of the saccharides, there is a problem that powdered materials (for example, the cellulose ether and saccharides) are not completely dissolved in a liquid material (for example, water) when preparing a liquid binder composition for solid foods.

The cellulose ether may include alkyl cellulose, hydroxyalkyl cellulose, hydroxyalkyl alkyl cellulose, or any combination thereof.

Specifically, the cellulose ether may include methyl cellulose, hydroxypropyl methyl cellulose, hydroxyethyl methyl cellulose, hydroxyethyl ethyl cellulose, hydroxyethyl cellulose, or any combination thereof.

The hydroxypropyl methyl cellulose may have a methyl substitution degree (DS) of 0.27 to 2.50 and may have a hydroxypropyl substitution degree (MS) of 0.02 to 1.1.

The hydroxyethyl methyl cellulose may have a methyl substitution degree (DS) of 0.27 to 2.40 and may have a hydroxyethyl substitution degree (MS) of 0.03 to 1.3.

The hydroxyethyl ethyl cellulose may have an ethyl substitution degree (DS) of 0.7 to 1.5 and may have a hydroxyethyl substitution degree (MS) of 0.5 to 2.5.

The hydroxyethyl cellulose may have a hydroxyethyl substitution degree (MS) of 0.3 to 5.0.

The aqueous solution of the cellulose ether having a concentration of 2 wt % may have a viscosity (hereinafter, referred to as “2 wt % aqueous solution viscosity”) of 3 mPa·s to 600 mPa·s, as measured by an Ubbelohde viscometer, under a condition of 20° C. When the viscosity of the aqueous solution of the cellulose ether is within the above range, it is possible to provide a binder composition for bar-shaped solid foods, the binding composition having excellent workability while exhibiting a sufficient thickening effect.

The saccharides may include sugar, starch syrup, or any combination thereof.

The binder composition for bar-shaped solid foods may further include water, but may not include at least one of fat and gelatin.

When the binder composition for bar-shaped solid foods includes a fat such as oil (for example, soybean oil, olive oil, canola oil, grapeseed oil, rice bran oil, corn oil, and/or palm oil), margarine, or butter, a deterioration in functional quality (abnormal taste or abnormal odor) due to fat rancidity may be caused during long-term storage.

Further, when the binder composition for bar-shaped solid foods includes gelatin as an animal material, there is a problem of causing a mad cow disease, thereby causing a consumer's reluctance.

The binder composition for bar-shaped solid foods according to an embodiment of the present disclosure, having the above configuration, is excellent in workability (for example, releasability), bindability, and appearance (for example, gloss), and suppresses fat rancidity and abnormal taste and abnormal odor due to the fat rancidity, thereby improving the storage stability of a final product together with the functional quality of the final product and providing a low-calorie bar-shaped solid food.

Another embodiment of the present disclosure provides a bar-shaped solid food manufactured from the above-described binder composition, wherein the bar-shaped solid food includes 100 parts by weight of saccharides and 2 parts by weight to 20 parts by weight of cellulose ether, and does not include a fat.

The bar-shaped solid food may be a cereal bar.

Hereinafter, the present disclosure will be described in more detail with reference to Examples, but the present disclosure is not limited to these Examples.

### EXAMPLES

Examples 1 to 5 and Comparative Examples 1 to 7

### (Preparation of Binder Compositions for Bar-Shaped Solid Foods)

Cellulose ethers and saccharides were blended in the weight ratios of Table 1 to prepare binder compositions for bar-shaped solid foods. The numbers in parentheses in Table 1 below indicate the contents of cellulose ether as parts by weight with respect to 100 parts by weight of the total content (based on solids) of corn syrup and sugar.

TABLE 1

| | Blending ratio (wt %) | | | | |
|---|---|---|---|---|---|
| | | Corn | | | |
| | HPMC^{*1} | syrup^{*2} | Sugar^{*3} | Oil^{*4} | Water |
| Example 1 | 4.1 | 28.7 | 21.3 | 0 | 45.9 |
| | (9.51) | | | | |
| Example 2 | 2.3 | 28.7 | 21.3 | 0 | 47.7 |
| | (5.33) | | | | |
| Example 3 | 8.6224 | 28.7 | 21.3 | 0 | 41.3776 |
| | (20) | | | | |
| Example 4 | 0.86224 | 28.7 | 21.3 | 0 | 49.13776 |
| | (2) | | | | |
| Example 5 | 4.1 | 0 | 21.3 | 0 | 74.6 |
| | (19.25) | | | | |
| Comparative | 0 | 57.4 | 21.3 | 9.8 | 11.5 |
| Example 1 | (0) | | | | |
| Comparative | 0 | 57.4 | 21.3 | 0 | 21.3 |
| Example 2 | (0) | | | | |
| Comparative | 0 | 28.7 | 21.3 | 0 | 50.0 |
| Example 3 | (0) | | | | |
| Comparative | 0 | 0 | 21.3 | 0 | 78.7 |
| Example 4 | (0) | | | | |
| Comparative | 0 | 0 | 64.3 | 0 | 25.9 |
| Example 5 | (0) | | | | |
| Comparative | 0.43112 | 28.7 | 21.3 | 0 | 49.56888 |
| Example 6 | (1) | | | | |
| Comparative | 9.05352 | 28.7 | 21.3 | 0 | 40.94648 |
| Example 7 | (21) | | | | |

^{*1}AnyAddy ® AN15 (hydroxypropyl methyl cellulose(HPMC), 2 kcal/g, 2 wt % aqueous solution viscosity: 15 mPa · s) of LOTTE Fine Chemical Co., Ltd.
^{*2}about 3 kcal/g, solid content 76 wt %
^{*3}4 kcal/g
^{*4}9 kcal/g, soybean oil

### EVALUATION EXAMPLES

### Evaluation Example 1: Evaluation of Workability (Releasability), Binding Force, and Appearance (Gloss)

The workability (releasability), binding force, and appearance (gloss) of the binder compositions for bar-shaped solid foods, prepared in Examples 1 to 5 and Comparative Examples 1 to 7, were evaluated by the following method, and the results thereof are given in Table 2 below.

(Evaluation Method)

(1) Evaluation Persons: 5

(2) Evaluation Method:

A sensory test was performed on the workability (releasability), binding force, and appearance (gloss) of each of the compositions by the following method. The sensory test was evaluated by five trained sensory test personnels with three ratings (excellent: ⊚, normal: Δ, poor: x), and the results thereof are given in Table 2 below.

### Evaluation Example 2: Hardness Evaluation

The hardness of each of the binder compositions for bar-shaped solid foods, prepared in Examples 1 to 5 and Comparative Examples 1 to 7, was measured by Texture Analyzer (Stable Micro System Co., Ltd., TA.TXPlus), and the results thereof are given in Table 2 below.

### Evaluation Example 3: Calorie Evaluation

The calorific value of each of the compositions was calculated using an Atwater index, and the results thereof are given in Table 2 below.

TABLE 2

| | Evaluation items | | | | |
|---|---|---|---|---|---|
| | | | | | Calorie |
| | Workability | Binding | Appearance | Hardness | (kcal/ |
| | (releasability) | force | (gloss) | (g) | 100 g) |
| Example 1 | ⊚ | ⊚ | ⊚ | 2.0 | 181 |
| Example 2 | ⊚ | ⊚ | ⊚ | 2.2 | 177 |
| Example 3 | ⊚ | ⊚ | ⊚ | 1.8 | 190 |
| Example 4 | ⊚ | ⊚ | ⊚ | 1.9 | 174 |
| Example 5 | ⊚ | ⊚ | Δ | 2.7 | 93 |
| Comparative | Δ | ⊚ | ⊚ | 2.7 | 348 |
| Example 1 | | | | | |
| Comparative | X | ⊚ | ⊚ | 1.7 | 260 |
| Example 2 | | | | | |
| Comparative | X | Δ | Δ | 2.2 | 172 |
| Example 3 | | | | | |
| Comparative | X | Δ | Δ | 2.6 | 85 |
| Example 4 | | | | | |
| Comparative | Not prepared | | | | |
| Example 5 | | | | | |
| Comparative | X | Δ | Δ | 1.8 | 173 |
| Example 6 | | | | | |
| Comparative | Not prepared | | | | |
| Example 7 | | | | | |

Referring to Table 2 above, it was found that in the binder compositions for bar-shaped solid foods, prepared in Examples 1 to 5, workability (releasability), binding force, and an appearance (gloss) are normal or more, and calorie is less than 190 kcal/100 g, which is low.

In contrast, it was found that in the binder compositions for bar-shaped solid foods, prepared in Comparative Examples 1 to 4 and 6, at least one of workability (releasability), binding force, and an appearance (gloss) is normal or less, and calorie is more than 250 kcal/100 g, which is high.

Meanwhile, it was found that in the binder composition for bar-shaped solid foods, prepared in Comparative Example 5, binding force is low, and thus it is impossible to manufacture a bar-shaped solid food.

Further, it was found that in the binder composition for bar-shaped solid foods, prepared in Comparative Example 7, when manufacturing a binder, powered materials are not completely dissolved in a liquid material and are lumped, and thus this binder composition is not suitable for a binder for bar-shaped solid foods.

Although the present disclosure has been described with reference to examples, it is merely exemplary, and those skilled in the art will understand that various modifications and equivalent other examples are possible therefrom. Therefore, the true technical protection scope of the present disclosure should be determined by the technical spirit of appended claims.

1. A binder composition for bar-shaped solid foods, the composition comprising: cellulose ether; and saccharides.

2. The binder composition of claim 1, wherein a content of the cellulose ether is 2 parts by weight to 20 parts by weight with respect to 100 parts by weight of a total content of the saccharides.

3. The binder composition of claim 1, wherein the cellulose ether includes alkyl cellulose, hydroxyalkyl cellulose, hydroxyalkyl alkyl cellulose, or any combination thereof.

4. The binder composition of claim 3, wherein the cellulose ether includes methyl cellulose, hydroxypropyl methyl cellulose, hydroxyethyl methyl cellulose, hydroxyethyl ethyl cellulose, hydroxyethyl cellulose, or any combination thereof.

5. The binder composition of claim 1, wherein an aqueous solution of the cellulose ether having a concentration of 2 wt % has a viscosity of 3 mPa·s to 600 mPa·s, as measured by an Ubbelohde viscometer, under a condition of 20° C.

6. The binder composition of claim 1, wherein the saccharides include sugar, starch syrup, or any combination thereof.

7. The binder composition of claim 1, wherein the binder composition further comprises water, but does not comprise at least one of fat and gelatin.

8. A bar-shaped solid food manufactured from the binder composition of claim 1, wherein the bar-shaped solid food comprises 100 parts by weight of saccharides and 2 parts by weight to 20 parts by weight of cellulose ether.

9. The bar-shaped solid food of claim 8, wherein the bar-shaped solid food further comprises water, but does not comprise at least one of fat and gelatin.
